(19) United States
(12) Patent Application Publication
(10) Pub. No.: US 2007/0222719 A1
(43) Pub. Date: Sep. 27, 2007

(54) Pixel driving method of organic light emitting diode display and apparatus thereof

(76) Inventors: Hui-Min Wang, Sinhua Township (TW); Yu-Wen Chiou, Sinhua Township (TW)

Correspondence Address: J.C. Patents, Inc., Suite 250, 4 Venture, Irvine, CA, 92618, US

(21) Appl. No.: 11/436,226

(22) Filed: May 17, 2006

(30) Foreign Application Priority Data
Mar. 24, 2006 (TW) 95110235

(51) Int. Cl. G09G 3/32

(52) U.S. Cl. 345/82

(57) ABSTRACT

A method pixel driving method of an organic light emitting diode (OLED) display and an apparatus thereof are provided. The method comprises the following steps. First, a pixel unit is reset to a predetermined voltage in a reset time period. After that, a frame period is divided into two driving time periods so that the pixel unit is finally charged to a pixel voltage. The charging process of the pixel unit is that the pixel unit is charged to a ground level in a first driving time period, and then the pixel unit is charged to the pixel voltage in a second driving time period.

### CROSS-REFERENCE TO RELATED APPLICATION

This application claims the priority benefit of Taiwan application serial no. 95110235, filed on Mar. 24, 2006. All disclosure of the Taiwan application is incorporated herein by reference.

### BACKGROUND OF THE INVENTION

1. Field of the Invention

The present invention relates to a pixel driving method of an organic light emitting diode (OLED) display and an apparatus thereof, and more particular, to the pixel driving method of an active OLED display and the apparatus thereof.

2. Description of Related Art

Organic light emitting diode (OLED) displays are mainly divided into two types according to their operating principle, namely, an active matrix type and a passive matrix type. Due to the higher operating efficiency and suitability for driving larger and higher resolution display devices, the active matrix driving method has currently become the principle mode of driving OLED displays.

FIG. 1 is a pixel driving circuit of a conventional active OLED display. As shown in FIG. 1, the pixel driving circuit includes a voltage driver 101 and a pixel unit 102. The pixel unit 102 is coupled to the output of the voltage driver 101. The pixel unit 102 further includes a diode D11, a capacitor C12, a transistor MN11 and a light emitting diode OLED1. The capacitor C11 is a parasitic capacitor between the anode of the diode D11 and a ground. The coupling relationships between various elements of the pixel unit 102 are as follows. The second diode D11 is serially connected between the output terminal of the voltage driver 101 and the capacitor C12. The capacitor C12 is serially connected between the cathode of the second diode D11 and the ground. The drain of the transistor MN11 is coupled to a reference voltage Vdd and the gate of the transistor MN11 is coupled to the cathode of the second diode D11. The light emitting diode OLED1 is serially connected between the source of the transistor MN11 and the ground.

As shown in FIG. 1, the pixel driving circuit of the conventional active OLED display operates by converting pixel data DATA through the voltage driver 101 into pixel voltage Vdata1 for driving the pixel unit 102. FIG. 2 is a timing diagram of a driving voltage Vwire1 for driving the pixel unit 102. The pixel unit 102, within one frame cycle but before driving to the pixel voltage Vdata1, a reset circuit (not shown) must reset the driving voltage Vwire1 to −10V and then charge to the pixel voltage Vdata1 according to the output of the voltage driver 101. The pixel voltage Vdata1 is between 0V to 5V and the voltage driver 101 is biased using two operating voltage sources, namely, −10V and 5V.

Furthermore, in the conventional technique, an additional diode D11 is frequently incorporated inside the pixel unit 102 to compensate for any deviation in the processing operation. With the additional diode D11, discharging the pixel unit 102 is virtually impossible. Hence, during the time period for charging the pixel unit 102 to the pixel voltage Vdata1, the voltage driver 101 having such a large driving capability may store substantial overshoot voltage in the capacitor C12 and lead to some variations in the pixel voltage Vdata1. Ultimately, the uniformity of display panel brightness may be affected.

### SUMMARY OF THE INVENTION

Accordingly, at least one objective of the present invention is to provide a pixel driving method for an active organic light emitting diode (OLED) display capable of reducing the overshoot voltage resulting from a driving voltage within one frame cycle. As a result, the uniformity of brightness in the display panel of the active OLED display is improved.

At least another objective of the present invention is to provide a pixel driving apparatus of an active organic light emitting diode (OLED) display that permits a voltage driver to operate using two operating voltage sources at lower voltage levels. Hence, circuit layout area is reduced and power consumption is lowered.

To achieve these and other advantages and in accordance with the purpose of the invention, as embodied and broadly described herein, the invention provides a pixel driving method of an organic light emitting diode (OLED) display. First, a pixel unit is reset to a predetermined voltage in a reset time period. After that, a frame period is divided into two driving time periods. The pixel unit is charged so that the pixel unit is finally charged to a pixel voltage. The charging process of the pixel unit is that the pixel unit is charged to a temporary level in a first driving time period, and then the pixel unit is charged to the pixel voltage in a second driving time period.

From another perspective, the present invention also provide a pixel driving apparatus for an organic light emitting diode (OLED) display. The pixel driving apparatus comprises a pixel unit, a first switch, a second switch and a voltage driver. A second terminal of the first switch and the second switch are couple to the pixel unit and a first terminal of the first switch and the second switch are coupled to a temporary level and an output terminal of the voltage driver respectively. The present invention uses the first switch and the second switch to control the driving voltage for driving the pixel unit. The first switch is turned on in a first driving time period to charge the pixel unit to the temporary level. Then, the second switch is turned on in a second driving time period to charge the pixel unit to the pixel voltage according to the output provided by the voltage driver.

In one embodiment of the foregoing pixel driving apparatus of the OLED display, the pixel unit is reset to a predetermined voltage before the first driving time period.

According to one preferred embodiment of the present invention, two switches are used to divide the process of charging of the pixel unit in a frame cycle into two separately executed driving time periods. As the pixel unit is charged in two time periods, the over-charging voltage associated with the driving voltage for driving the pixel unit is reduced so that the uniformity of brightness in the display panel is improved. In addition, the driver in the present invention occupies a smaller circuit area and consumes less power compared with a conventional driver design.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a pixel driving circuit of a conventional active organic light emitting diode display.

FIG. 2 is a voltage waveform diagram of the driving voltage used in the conventional technique shown in FIG. 1.

FIG. 3 is a circuit diagram of a pixel driving apparatus of an active OLED display according to one embodiment of the present invention.

FIG. 4 is a voltage waveform diagram of the driving voltage described in the FIG. 3.

FIG. 5 is a flow diagram showing the steps in the pixel driving method for driving an active OLED display according to one embodiment of the present invention.

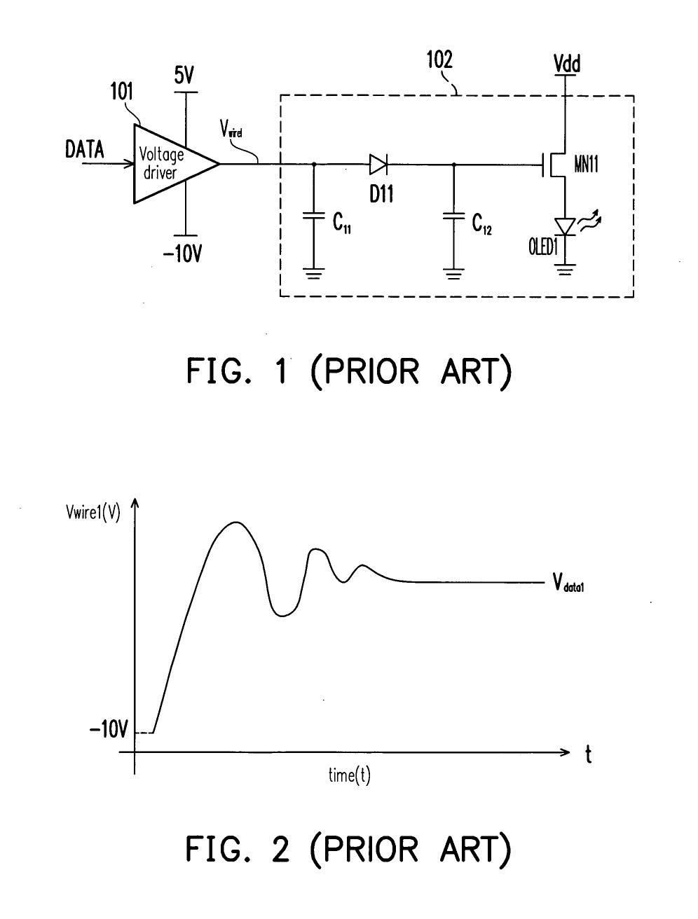

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

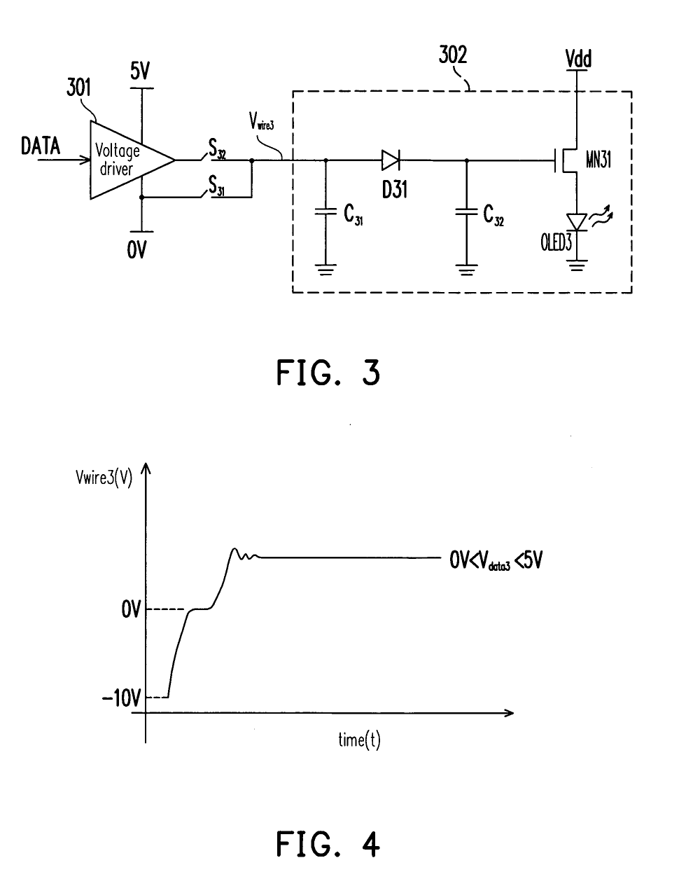

FIG. 3 is a circuit diagram of a pixel driving apparatus of an active OLED display according to one embodiment of the present invention. The pixel driving apparatus includes a voltage driver 301, a first switch S31, a second switch S32 and a pixel unit 302. An output terminal of the voltage driver 301 is coupled to a first terminal of the second switch S32. A second terminal of the second switch S32 is coupled to the pixel unit 302. A first terminal and a second terminal of the first switch S31 are coupled to a ground terminal and the pixel unit 302 respectively.

In the present embodiment, the pixel unit 302 includes capacitors C31 and C32, a diode D31, a first transistor MN31 and a light emitting diode OLED3. The anode of the diode D31 and the ground form the parasitic capacitor C31. The capacitor C32 is serially connected between the cathode of the diode D31 and the ground. The drain of the transistor MN31 is coupled to an operating voltage Vdd and the gate of the transistor MN31 is coupled to the cathode of the diode D31. The anode and cathode of the light emitting diode OLED3 are coupled to the source of the transistor MN31 and the ground respectively.

The diode D31 in the foregoing pixel unit 302 is used to compensate any abnormality of the device during the manufacturing process when the pixel driving apparatus utilizes the current generated by the transistor MN31 to drive the light emitting diode OLED3. In one frame cycle, if the driving voltage Vwire3 for driving the pixel unit 302 has a substantial overshoot, the overshoot voltage is stored in the capacitor C32 because discharging the pixel unit 302 in the presence of the diode D31 is impossible. In the present embodiment, using two switches S31 and S31 coupled to the pixel unit 302, the overshoot voltage generated by the driving voltage Vwire3 within one frame cycle is lowered. The related operating principles are described below.

FIG. 4 is a voltage waveform diagram of the driving voltage Vwire3 according to one embodiment of the present invention. Refer to FIGS. 3 and 4 for an explanation of the operating principles of the present embodiment. The pixel driving apparatus is used for charging the pixel unit 302 to the required pixel voltage Vdata3 through the voltage driver 301 within one frame cycle according to the input pixel data DATA. Before entering this frame cycle, the driving voltage Vwire3 used for driving the pixel unit 302 is reset to a predetermined preset voltage (for example, −10V in the present embodiment) by a reset circuit (not shown). Then, a frame cycle is divided into two stages (a first driving time period and a second driving time period) for separately charging the pixel unit 302. In the first driving time period, the pixel driving apparatus turns on the switch S31 but turns off the switch S32 so that the driving voltage Vwire3 rises from the original predetermined voltage (−10V) to a temporary voltage level. In the present embodiment, the temporary level is, for example, a ground level (0V) so that the pixel unit 302 is charged to the ground level (0V). Thereafter, in the second driving time period, the switch S31 is turned off while the switch S32 is turned on so that the pixel unit 302 is coupled to the output terminal of the voltage driver 301. Therefore, the voltage driver 301 can charge the pixel unit 302 to the pixel voltage Vdata3 according to the input pixel data DATA. In other words, the driving voltage Vwire3 rises from the ground level (0V) to the pixel voltage Vdata3 during the second driving time period as shown in FIG. 4. In the present embodiment, the temporary level is between −10V to 5V, preferably between −1V to 4.5V. The pixel voltage Vdata3 is between 0V to 5V. Furthermore, the two operating voltages for operating the voltage driver 301 are between 0V to 5V.

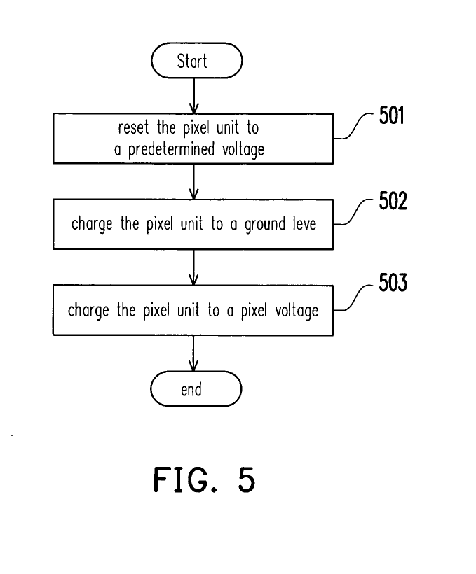

FIG. 5 is a flow diagram showing the steps in the pixel driving method for driving an active OLED display according to one embodiment of the present invention. This portion can be viewed in combination with that shown in FIG. 4. The steps for charging the pixel unit in the present embodiment include the following. First, before stepping into a frame cycle, the pixel unit is reset to a predetermined voltage (501). Then, the frame cycle is divided into two portions, that is, a first driving time period and a second driving time period for charging the pixel unit in two separate stages. In the first driving time period, the pixel unit is charged to a ground level (502). Immediately, in the second driving time period, the voltage driver charges the pixel unit to a pixel voltage (503) according to the pixel data, thereby completing the charging action within one frame cycle. The predetermined voltage is smaller than the ground level. In the present embodiment, the predetermined voltage is −10V and the pixel voltage Vdata3 is between 0V to 5V.

In summary, the pixel driving method for driving an active OLED display and apparatus thereof in the present invention utilize two switches coupled to the pixel unit as controlling switches. Through the controlling switches, the driving voltage for driving the pixel unit rises to a ground level first before rising to the pixel voltage of the voltage driver according to the output of the pixel data. Thus, the overshoot voltage produced by the driving voltage within a frame cycle is reduced and the brightness of the display panel of the active OLED display is more uniform. Furthermore, the two operating voltages required to drive the voltage driver are between 0V to 5V. Thus, compared with the conventional technique that requires the voltage driver to operate between −10V to 5V, the present invention not only simplifies the circuit design, but also provides obvious improvements to circuit layout and power consumption as well.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel driving method of an active organic light emitting diode (OLED) display for charging a pixel unit to a pixel voltage in a frame cycle, comprising the steps of:
resetting the pixel unit to a predetermined voltage during a reset time period;
charging the pixel unit to a temporary level during a first driving time period; and
charging the pixel unit to the pixel voltage during a second driving time period.

2. The pixel driving method of claim 1, wherein the frame cycle comprises the first driving time period and the second driving time period, and the first driving time period is before the second driving time period.

3. The pixel driving method of claim 1, wherein the predetermined voltage is smaller than the temporary level.

4. The pixel driving method of claim 3, wherein the predetermined voltage is −10V.

5. The pixel driving method of claim 1, wherein the pixel voltage is greater than the temporary level.

6. The pixel driving method of claim 1, wherein the level of the pixel voltage is determined according to a pixel data.

7. The pixel driving method of claim 1, wherein the temporary level is between −1V to 4.5V.

8. The pixel driving method of claim 7, wherein the temporary level is 0V.

9. A pixel driving apparatus of an active organic light emitting diode (OLED) display, comprising:
a pixel unit;
a voltage driver for outputting a pixel voltage in a frame cycle according to a pixel data, wherein the frame cycle comprises a first driving time period and a second driving time period;
a first switch having a first terminal coupled to a temporary level and a second terminal coupled to the pixel unit, wherein the first terminal and the second terminal of the first switch are connected during the first driving time period; and
a second switch having a first terminal coupled to an output terminal of the voltage driver and a second terminal coupled to the pixel unit, wherein the first terminal and the second terminal of the second switch are connected during the second driving time period.

10. The pixel driving apparatus of claim 9, wherein the pixel unit comprises:
a diode having an anode coupled to the second terminal of the first switch and the second switch;
a capacitor having a first terminal coupled to a cathode of the diode and a second terminal coupled to a first voltage;
a first transistor having a first source/drain terminal coupled to an operating voltage and a gate coupled to the first terminal of the capacitor; and
a light emitting diode having an anode coupled to a second source/drain terminal of the first transistor and a cathode coupled to a second voltage.

11. The pixel driving apparatus of claim 10, wherein the first voltage and the second voltage are a ground level.

12. The pixel driving apparatus of claim 10, wherein the diode comprises a second transistor having a gate and a source mutually connected to form the anode of the diode and a drain serving as the cathode of the diode.

13. The pixel driving apparatus of claim 9, wherein the first driving time period is before the second driving time period.

14. The pixel driving apparatus of claim 9, wherein, before the first driving time period, the pixel unit is reset to a predetermined voltage.

15. The pixel driving apparatus of claim 14, wherein the predetermined voltage is smaller than the temporary level.

16. The pixel driving apparatus of claim 15, wherein the predetermined voltage is −10V.

17. The pixel driving apparatus of claim 9, wherein the pixel voltage is greater than the temporary level.

18. The pixel driving apparatus of claim 9, wherein the operating voltage of the voltage driver is between 0V to 5V.

19. The pixel driving apparatus of claim 9, wherein the temporary level is between −1V to 4.5V.

20. The pixel driving apparatus of claim 19, wherein the temporary level is 0V.
